(19) United States
(12) Patent Application Publication
(10) Pub. No.: US 2025/0307599 A1
(43) Pub. Date: Oct. 2, 2025

(54) MANIFOLD-ALIGNED COUNTERFACTUAL EXPLANATIONS

(71) Applicant: International Business Machines Corporation, Armonk, NY (US)

(72) Inventors: Asterios Tsiourvas, Cambridge, MA (US); Wei Sun, Scarsdale, NY (US); Markus Ettl, Yorktown Heights, NY (US)

(21) Appl. No.: 18/618,596

(22) Filed: Mar. 27, 2024

(51) Int. Cl. G06N 3/043

(52) U.S. Cl. CPC G06N 3/043

(57) ABSTRACT

One or more computer processors responsive to receiving an input, a trained model, a trained model outcome, a local outlier factor (LOF) threshold, and a maximum number of live polytopes to search over, generating an optimization problem to determine an output that is closest to the input with respect to a distance measure. The one or more computer processors transform a LOF constraint into a set of linear mixed integer constraints and a set of quadratic mixed integer constraints, utilizing the distance measure. The one or more computer processors decompose an input space into a plurality of polytopes based on a geometry associated with the trained model. The one or more computer processors generate a counterfactual based on the plurality of polytopes.

### STATEMENT REGARDING PRIOR DISCLOSURES BY THE INVENTOR OR A JOINT INVENTOR

The following disclosure(s) are submitted under 35 U.S.C. 102(b)(1)(A):
(i) “Manifold-Aligned Counterfactual Explanations for Neural Networks”; Asterios Tsiourvas, Wei Sun, Markus Ettl; Oct. 1, 2023.

### BACKGROUND

The present invention relates generally to the field of machine learning, and more particularly to neural networks.

Neural networks (NNs) are computing systems inspired by biological neural networks. NNs are not simply algorithms, but rather a framework for many different machine learning algorithms to work together and process complex data inputs. Such systems “learn” to perform tasks by considering examples, generally without being programmed with any task-specific rules. For example, in image recognition, NNs learn to identify images that contain cats by analyzing example images that are correctly labeled as “cat” or “not cat” and using the results to identify cats in other images. NNs accomplish this without any prior knowledge about cats, for example, that cats have fur, tails, whiskers, and pointy ears. Instead, NNs automatically generate identifying characteristics from the learning material. NNs are based on a collection of connected units or nodes called artificial neurons, which loosely model the neurons in a biological brain. Each connection, like the synapses in a biological brain, can transmit a signal from one artificial neuron to another. An artificial neuron that receives a signal can process the signal and then transfer the signal to additional artificial neurons.

In common NN implementations, the signal at a connection between artificial neurons is a real number, and the output of each artificial neuron is computed by some non-linear function of the sum of its inputs. The connections between artificial neurons are called ‘edges’. Artificial neurons and edges typically have a weight that adjusts as learning proceeds. The weight increases or decreases the strength of the signal at a connection. Artificial neurons may have a threshold such that the signal is only sent if the aggregate signal crosses that threshold. Typically, artificial neurons are aggregated into layers. Different layers may perform different kinds of transformations on their inputs. Signals travel from the first layer (i.e., input layer), to the last layer (i.e., output layer), possibly after traversing the layers multiple times.

In a neural network, the activation function is responsible for transforming the summed weighted input from the node into the activation of the node or output for that input. The rectified linear activation function (ReLU) is a piecewise linear function that outputs an input directly if it is positive, otherwise, it will output zero.

### SUMMARY

Embodiments of the present invention disclose a computer-implemented method, a computer program product, and a system. The computer-implemented method includes one or more computer processers, responsive to receiving an input, a trained model, a trained model outcome, a local outlier factor (LOF) threshold, and a maximum number of live polytopes to search over, generating an optimization problem to determine an output that is closest to the input with respect to a distance measure. The one or more computer processors transform a LOF constraint into a set of linear mixed integer constraints and a set of quadratic mixed integer constraints, utilizing the distance measure. The one or more computer processors decompose an input space into a plurality of polytopes based on a geometry associated with the trained model. The one or more computer processors generate a counterfactual based on the plurality of polytopes.

### BRIEF DESCRIPTION OF THE DRAWINGS

FIG. 1 is a functional block diagram illustrating a computing environment, in accordance with an embodiment of the present invention;

FIG. 2 is a flowchart depicting operational steps of a program, on a computer within the computing environment of FIG. 1, for generating neural network counterfactual explanations, in accordance with an embodiment of the present invention;

FIG. 3 is a plurality of charts, in accordance with an embodiment of the present invention;

FIG. 4 is a chart, in accordance with an embodiment of the present invention; and

FIG. 5 is a heuristic, in accordance with an embodiment of the present invention.

### DETAILED DESCRIPTION

Today exists a growing demand for interpretable AI, where humans can understand machine learning models. Counterfactual explanations have been used to explain model predictions and provide actionable insights. Specifically, for a data point, a counterfactual explanation identifies a minimum change that will lead to a different outcome under a given predictive model. A desirable property of counterfactual explanations is being realistic. Take the example of a loan application where an applicant got rejected by a machine learning model, which considers various features, such as the applicant income and loan amount. A recommendation of reducing the loan amount by 5% to gain loan approval is far more realistic to execute, hence a more desirable counterfactual explanation, compared to an alternative suggestion of doubling the income.

Neural networks, especially with non-linear activations such as ReLU, have gained immense popularity due to their remarkable ability to model complex nonlinear relationships in data, making them a ubiquitous technology across applications. However, due to associated complex structure, obtaining high quality counterfactual explanations that are both optimal (measured in terms of the minimum distance from the given sample point) and realistic remains a challenging task.

ReLU networks have gained significant attention because of their inherent piecewise linear structure which promotes analytical tractability. This structure has been utilized for a variety of applications, such as robustness verification and network compression. Research has focused on optimizing already trained ReLU networks for down-stream tasks, utilizing both mixed-integer optimization and approximate methods.

To generate counterfactual explanations from ReLU networks, people have mostly used mixed integer programming (MIP) or satisfiability modulo theories (SMT) solvers. While both approaches offer optimality guarantees in terms of their proximity to the factual sample when compared to model-agnostic approaches, their extensive runtime severely hinders their practicality. For instance, SMT solvers show that even for small ReLU networks (i.e., 1 hidden layer with 20 neurons), SMT solvers fail to scale effectively. While MIP-based optimization methods for counter-factual explanations have found their successes for simpler linear models or tree-based models, said methods are only limited to moderate-sized neural networks due to associated computational challenges.

A crucial requirement for counterfactual explanations is realism. To measure the realism of counterfactual explanations, one of the most well-known metrics is Local Outlier Factor (LOF). The LOF score for a data point measures the local deviation in the density of a given sample, i.e., a low LOF score signifies a stronger alignment of the resulting counterfactual explanation with the data distribution, while a high LOF score indicates that a data point is an outlier. The vast majority of the literature has utilized LOF as an evaluation metric. With the exception of SMT solvers, existing work merely utilizes LOF as an evaluation metric. SMT solvers propose an MIP approach that utilizes a special case of LOF (nearest neighbor equal to 1) as a regularization term in the objective. While this approach encourages the generation of realistic counterfactual explanations, it does not explicitly guarantee manifold alignment and requires tuning the regularization hyperparameter and is only applicable to linear and tree-based models.

Embodiments of the present invention propose an efficient heuristic with a provable guarantee that provides a solution for an issue of increased computational cost when a number of live regions expand. Embodiments of the present invention improve computation tractability by restricting a search space to live polytopes. Embodiments of the present invention explicitly incorporate constraints that achieve a desirable LOF value of counterfactual explanations due to its nonlinearity and computational complexity.

Embodiments of the present invention explicitly enforce manifold alignment constraints into an optimization problem by reformulating a LOF metric as a set of mixed-integer constraints. Embodiments of the present invention guarantee an adherence of a resulting optimal solution to the underlying data distribution, i.e., a more realistic counterfactual explanation. Embodiments of the present invention show that with [symbol] ₁ or [symbol] _{∞} norms as the distance measure, embodiments obtain a set of mixed integer linear constraints. Meanwhile, with [symbol] ₂ norm, it gives rise to a set of mixed-integer quadratic constraints. Embodiments of the present invention show that in addition to neural networks, this result on reformulating LOF such that the manifold alignment constraints can then be easily incorporated into the counterfactual explanation problem is applicable to any type of machine learning model that can be expressed by mixed-integer constraints, such as logistic regression, decision trees, tree ensembles, and more.

Some embodiments of the present invention recognize that even in the absence of the manifold alignment constraint, the initial MIP formulation that determines the optimal counterfactual explanation can easily become intractable due to the large number of binary decision variables required to model the complex neural network structure. Some embodiments of the present invention recognize that having the LOF constraint exacerbates the existing computational challenge. Embodiments of the present invention propose an efficient decomposition scheme that utilizes the geometry of ReLU networks and reduces the initial large, hard-to-solve optimization problem into a series of significantly smaller and easier-to-solve problems. Embodiments of the present invention limit the search space to live polytopes, i.e., polytopes of the input space generated by the network that contain at least one data point in the desired outcome class. Embodiments of the present invention further enhance the proposed decomposition scheme by strategically selecting a subset of live polytopes as a search space. Embodiments of the present invention show analytically that a probability of missing a live polytope that yields an optimal solution decreases exponentially as a subset size increases.

Embodiments of the present invention consistently produce realistic and closer counterfactual explanations to the factual data. Embodiments of the present invention, for larger and more complex neural networks, show that the proposed decomposition scheme achieves significant gains in computational tractability. Embodiments of the present invention reveal, besides the speedup, an added benefit of leveraging the live polytopes which implicitly encourage realistic counterfactual explanations even without explicitly enforcing the manifold alignment constraint.

Embodiments of the present invention provide a solution for the problem of finding optimal manifold-aligned counterfactual explanations for neural networks. Embodiments of the present invention that existing approaches that suffer from scalability issues, limiting their practical usefulness, furthermore, the solutions are not guaranteed to follow the data manifold, resulting in unrealistic counterfactual explanations. Embodiments of the present invention address these challenges by presenting a MIP formulation where the present invention explicitly enforce manifold alignment by reformulating the highly nonlinear Local Outlier Factor (LOF) metric as mixed-integer constraints. Embodiments of the present invention address the computational challenge by leveraging a geometry of a trained neural network and with an efficient decomposition scheme that reduces the initial large, hard-to-solve optimization problem into a series of significantly smaller, easier-to-solve problems by constraining the search space to “live” polytopes, i.e., regions that contain at least one actual data point.

Embodiments of the present invention demonstrate efficacy in producing both optimal and realistic counterfactual explanations, as well as computational tractability. Embodiments of the present invention take advantage of the underlying geometry of trained ReLU networks, which partition the input space into polytopes, where in each polytope, the network reduces to a linear model leading to a decomposition scheme that reduces the initial large, hard-to-solve MIP into a series of significantly smaller and easier-to-solve problems. Embodiments of the present invention limit the search space to “live” polytopes, i.e., polytopes that contain actual data points.

Embodiments of the present invention generate counterfactual explanations from trained machine learning models to provide interpretability as well as actionable insights. Embodiments of the present invention demonstrate that manifold alignment constraints based on the popular LOF metric can be directly incorporated into the optimization problem. This is achieved by reformulating the LOF metric into a set of mixed-integer constraints. Embodiments of the present invention show that this result can be applied to any machine learning model that can be expressed as a set of mixed-integer constraints. Embodiments of the present invention circumvent the computational challenges of the resulting MIP problem with an efficient decomposition scheme that leverages the geometry of ReLU networks and significantly reduces the search space into a moderately sized set of polytopes. Implementation of embodiments of the invention may take a variety of forms, and exemplary implementation details are discussed subsequently with reference to the Figures.

The present invention will now be described in detail with reference to the Figures.

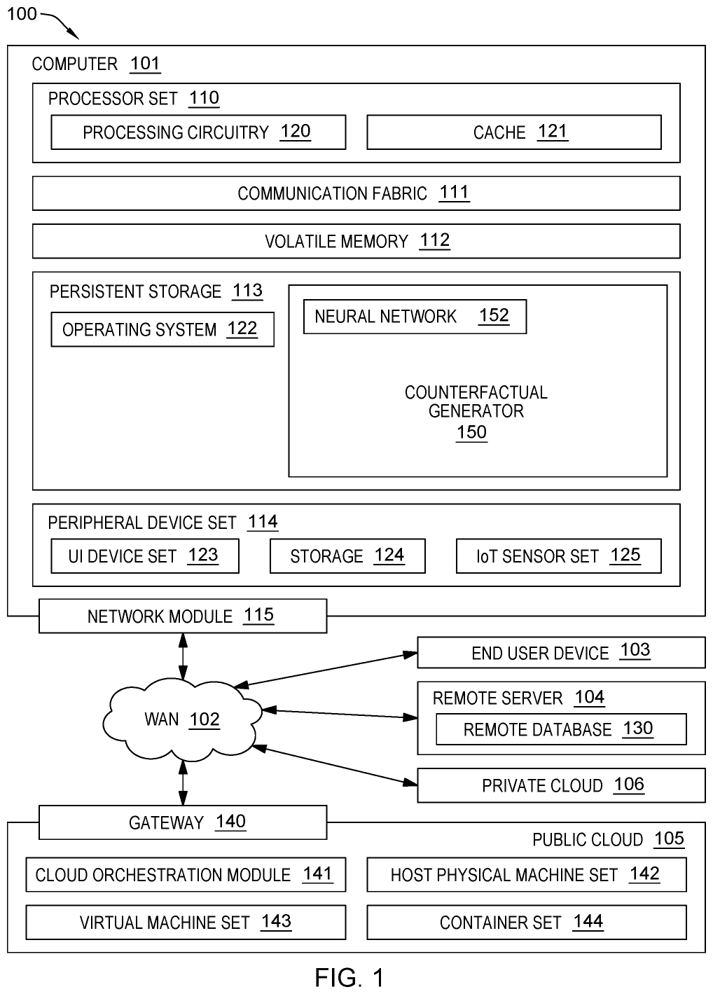

FIG. 1 depicts computing environment 100 illustrating components of computer 101 in accordance with an illustrative embodiment of the present invention. It should be appreciated that FIG. 1 provides only an illustration of one implementation and does not imply any limitations with regard to the environments in which different embodiments may be implemented. Many modifications to the depicted environment may be made.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation, or garbage collection, but this does not render the storage device as transitory because the data is not transitory while it is stored.

Computing environment 100 contains an example of an environment for the execution of at least some of the computer code involved in performing the inventive methods, such as counterfactual generator 150, hereinafter referred to as program 150. In addition to program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip”. In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in program 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

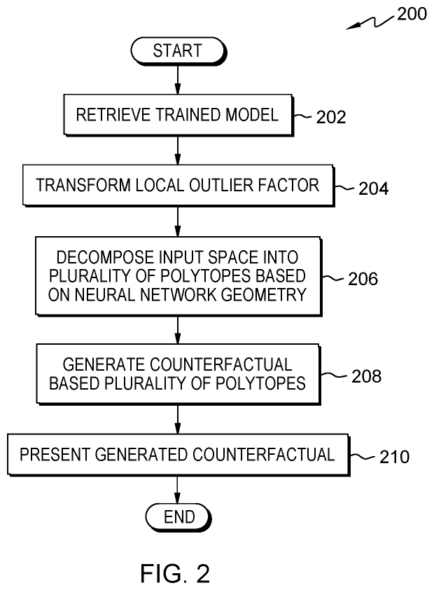

Program 150 is a program, a subprogram of a larger program, an application, a plurality of applications, or mobile application software, which functions to generate neural network counterfactual explanations. In various embodiments, program 150 may implement the following steps: responsive to receiving an input, a trained model, a trained model outcome, a local outlier factor (LOF) threshold, and a maximum number of live polytopes to search over, generate an optimization problem to determine an output that is closest to the input with respect to a distance measure; transform a LOF constraint into a set of linear mixed integer constraints and a set of quadratic mixed integer constraints, utilizing the distance measure; decompose an input space into a plurality of polytopes based on a geometry associated with the trained model; and generate a counterfactual based on the plurality of polytopes. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over WAN 102. In various embodiments, client versions of program 150 resides on any other computing device (not depicted) within computing environment 100. In the depicted embodiment, program 150 includes neural network 152. Program 150 is depicted and described in further detail with respect to FIG. 2.

Neural network 152 is representative of a neural network utilizing deep learning techniques to train, calculate weights, ingest inputs, and output a plurality of solution vectors. In an embodiment, neural network 152 is comprised of any combination of deep learning model, technique, and algorithm (e.g., decision trees, Naive Bayes classification, support vector machines for classification problems, random forest for classification and regression, linear regression, least squares regression, logistic regression). In an embodiment, neural network 152 utilizes transferrable neural networks algorithms and models (e.g., long short-term memory (LSTM), deep stacking network (DSN), deep belief network (DBN), convolutional neural networks (CNN), compound hierarchical deep models) that can be trained with supervised or unsupervised methods. In the depicted embodiment, neural network 152 is a trained rectified linear unit (ReLU) neural network. Neural network 152 is depicted and described in further detail with respect to FIG. 2.

In an embodiment, neural network 152 utilizes an business income dataset (e.g., d=73), where the goal is to predict whether a business has an income of over $50,000, the FICO dataset (e.g., d=34) to predict the chances of default, and lastly, a credit dataset (d=27) to classify the credit of an business as good or bad. In an embodiment, for all datasets, program 150 performs one-hot encoding to incorporate categorical variables. In an embodiment, program 150 scales all continuous features using the min-max scaler to ensure that their domain falls within the range of [0, 1]. For the default dataset, program 150 utilizes an existing train-test split, while for the remaining datasets program 150 randomly splits each dataset into into train (70%) and test (30%) instances. In an embodiment, neural network 152 is a three 2-layer, densely connected ReLU networks with 50, 100 and 200 neurons per hidden layer respectively. In an embodiment, program 150 trains neural network 152 with a learning rate of 0.001 and a batch size of 128 for 20 epochs with early stopping (e.g., patience 3).

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

FIG. 2 depicts flowchart 200 illustrating operational steps of program 150 for generating neural network counterfactual explanations, in accordance with an embodiment of the present invention.

Program 150 retrieves a trained model (step 202). In an embodiment, program 150 initiates responsive to a trained neural network 152 (e.g., trained to predict loan approval). In another embodiment, program 150 initiates responsive to an input data sample. In another embodiment, program 150 initiates responsive to a user defined neural network 152 outcome (e.g., loan approval).

In an embodiment, program 150 denotes χ⊆ [symbol] ^{d} as an input space and [symbol] ={xᵢ∈χ}ᵢ₌₁ⁿ be a dataset consisting of a number, n, of datapoints. In another embodiment, program 150 denotes f:χ→[0,1] as a machine learning model (e.g., neural network 152) that takes a d-dimensional sample as an input and outputs a probability between 0 and 1. In yet another embodiment, program 150 calculates a final decision denoted by 1[f(x)≥0.5], where 1[⋅] is an indicator function. In an embodiment, all x∈ [symbol] for which f(x)<0.5 belong to a negative class [symbol] ₋, while all x∈X for which f(x)≥0.5 belong to a positive class [symbol] ₊. In an embodiment, program 150 defines [symbol] ₋∩ [symbol] ₊=∅, [symbol] ₋∪ [symbol] ₊= [symbol] , and | [symbol] ₋|=n₋ and | [symbol] ₊|=n₊, with n=n₋+n₊. In another embodiment, program 150 defines [n]:={1, . . . , n}.

In an embodiment, program 150 retrieves a factual data sample x_{F}∈χ such that f(x_{F})<0.5, a closest counterfactual with respect to f(⋅) in terms of a [symbol] ₚ norm, is a point that is the solution of the following optimization problem:

$$\begin{matrix}{x}_{CF} := {arg min}_{x ∈ 𝒳} & {‖ {x}_{F} - x ‖}_{p} \\ s . t . & f ( x ) \geq 0.5 .\end{matrix} \qquad 1 )$$

The complexity of problem (1) depends on a structure of f(⋅). For example, for well-known norms where p∈{1, 2, ∞}, if f(⋅) is a linear model, problem (1) is either a linear or a quadratic mixed-integer optimization problem which is significantly more difficult and computationally intensive to solve. In an embodiment, f(⋅) is a trained rectified linear unit (ReLU) neural network.

In an embodiment, neural network 152 is a densely connected architecture, wherein each comprised neuron receives inputs from one or more neurons in a preceding layer. In another embodiment, an output layer of neural network 152 consists of a single neuron that outputs a probability via a sigmoid function.

In an embodiment, program 150 defines neural network 152 as a function f:χ→ [symbol] . In an embodiment, program 150 denotes a number of hidden layers as L and a number of neurons at layer i as nᵢ. In another embodiment, program 150 denotes an output of layer i as xᵢ∈ [symbol] ⁿ^{ᵢ}. In another embodiment, program 150 defines x^{o}:=x, nₒ:=d, n_{L+1}:=1. In another embodiment, program 150 defines neurons by a weight matrix Wⁱ∈ [symbol] ⁿ^{ᵢ}^{×n}^{_{i−1}} and a bias vector bⁱ∈ [symbol] ⁿ^{ᵢ}. In another embodiment, program 150 defines xⁱ as xⁱ=max{Wⁱxⁱ⁻¹+bⁱ, 0}, where max{⋅,0} is the ReLU function. In yet another embodiment, program 150 defines an output of neural network 152 as f(x)=σ(W^{L+1}x^{L}+b^{L+1}), where σ(⋅) is a sigmoid activation (i.e., σ(x)=(1+e^{-x})⁻¹.

In an embodiment, f(⋅) is a trained ReLU neural network, where the constraint f(x)≥0.5 of problem (1) is expressed as a set of mixed-integer linear constraints. In another embodiment, for layer i, an equality constraint xⁱ=max{Wⁱxⁱ⁻¹+bⁱ, 0}, is equalivent to xⁱ∈C(xⁱ⁻¹) where:

$$C ( {x}^{i - 1} ) = \{ \begin{matrix}y \geq {W}^{i} {x}^{i - 1} + {b}^{i} , \\ y \leq {W}^{i} {x}^{i - 1} + {b}^{i - 1} - {l}^{i} ⊙ ( 1 - {z}^{i} ) , \\ y \leq {u}^{i} ⊙ {z}^{i} , y \geq 0\end{matrix} \} .$$

In an embodiment, program 150 defines C(x¹⁻¹), zⁱ∈{0,1}ⁿ^{ᵢ} are binary variables with zⱼⁱ being equal to 1 if neuron j of layer i is activated and 0 otherwise, ⊙ denotes element-wise multiplication, uⁱ is an upper bound of xⁱ and lⁱ is a lower bound. In another embodiment, the upper and lower bounds uⁱ and lⁱ are calculated sequentially by solving the following problems

$${u}^{i} = {max}_{{l}^{i - 1} \leq {x}^{i - 1} \leq {u}^{i - 1}} \{ {W}^{i} {{x}^{i - 1}}^{} + {b}^{i} \} and {l}^{i} = {min}_{{l}^{i - 1} \leq {x}^{i - 1} \leq {u}^{i - 1}} \{ {W}^{i} {x}^{i - 1} + {b}^{i} \} .$$

In another embodiment, for x⁰, program 150 obtains upper and lower bounds from χ. In an embodiment, program 150 retrieves a user-specified distance measure that quantifies a difference between two sample points (e.g., [symbol] ₁ or [symbol] ₂, [symbol] _{∞}), where the distance measures comprise a minimum distance (e.g., [symbol] ₁, [symbol] _{∞}), ) and a maximum distance. In another embodiment, program 150 reformulates problem (1) as the following mixed-integer optimization (MIP):

$$\begin{matrix}{min}_{{x}^{0} ∈ 𝒳 , {x}^{1} , … , {x}^{L} , {z}^{1} , … , {z}^{L}} & {‖ {x}_{F} - {x}^{0} ‖}_{p} \\ s . t . & {x}^{i} ∈ C ( {x}^{i - 1} ) , ∀ i ∈ [ L ] , \\ & {W}^{L + 1} {x}^{L} + {b}^{L + 1} \geq 0 ,\end{matrix} \qquad 2 )$$

with respect to equation (2), where the last constraint comes from a requirement that f(x⁰)≥0.5→σ(W^{L+1}x^{L}+b^{L+1})≥0.5→W^{L+1}x^{L}+b^{L+1}≥0≥σ⁻¹(0.5)=0. In an embodiment, program 150 defines an optimal xₒ as a closest counterfactual x_{CF}. In an embodiment, equation (2) requires Σᵢ₌₁^{L}nⁱ binary, and d+Σᵢ₌₁^{L}nⁱ continuous variables.

Program 150 transforms local outlier factor (LOF) constraint into a set of mixed integer constraints (step 204). Embodiments of the present invention recognize that given modeling flexibility, that a ReLU network may produce counterfactuals that deviates significantly from the data manifold, leading to unrealistic explanations. In an embodiment, program 150 utilizes Local Outlier Factor (LOF) as a metric to quantify whether a sample follows an underlying data distribution. In an embodiment, program 150 retrieves a user-specified threshold as a maximum LOF score, i.e., a sample with LOF lower than t is considered realistic, or adheres to the manifold (e.g., t=1).

In an embodiment, program 150 defines LOF as such: for x∈ [symbol] , let Nₖ(x) to be its k-Nearest Neighbors in [symbol] . In an embodiment, the k-reachability distance rdₖ of x with respect to x′ is defined by rdₖ(x, x′)=max{δ(x, x′), dₖ(x′)}, where dₖ(x′) is the distance δ between x′ and its k-th nearest instance in [symbol] . In another embodiment, program 150 defines a k-local reachability density of x by lrdₖ(x)=|Nₖ(x)|(Σ_{x′∈N}_{ₖ}^{(x)}rdₖ(x, x′))⁻¹. In another embodiment, program 150 defines the k-LOF of x as:

$$L O {F}_{k , 𝒟} ( x ) = \frac{1}{\vert {N}_{k} ( x ) \vert} {\sum }_{{x}^{1} ∈ {N}_{k} ( x )} \frac{{lrd}_{k} ( {x}^{′} )}{{lrd}_{k} ( x )} .$$

In an embodiment, for a distance metric δ: χ×χ→ [symbol] _{≥0}, program 150 defines a [symbol] ₚ norm with p∈{1, 2, ∞}. In another embodiment, by convention, a value of LO [symbol] (x)≤1indicates that x is an inlier that is aligned with a data manifold, while LO [symbol] (x)>1 indicates that x is an outlier.

In an embodiment, program 150 utilizes LOF as a post-process evaluation metric that measures whether a learned closest counterfactual follows a data manifold. In the depicted embodiment, program 150 incorporates LOF into a constraint that requires a resulting counterfactual explanation to be close a data manifold by solving the following optimization problem:

$$\begin{matrix}{min}_{x ∈ 𝒳 ,} & {‖ {x}_{F} - {x}^{0} ‖}_{p} \\ s . t . & f ( x ) \geq 0 \text{.5} , \\ & L O {F}_{k , 𝒟} ( x ) \leq τ ,\end{matrix} \qquad 3 )$$

where t is a user-defined threshold. In an embodiment, program 150 reformulates said constraint that is in terms of LOF and appears nonlinear, into a set of mixed-integer optimization constraints.

In an embodiment, program 150 expresses a constraint LO [symbol] (x)≤t for x∈χ, fixed k, and p∈{1, ∞} as a set of mixed-integer linear constraints. In an embodiment, if p=2, program 150 expresses the constraint as a set of mixed-integer quadratic constraints. The present invention demonstrates that a k-reachability distance rdₖ that utilizes a maximum operator may be linearized with algebraic manipulations and an introduction of additional binary variables. In an embodiment, program 150 applies the embodiments in this paragraph to any machine learning model that is capable of being expressed via a set of mixed-integer constraints. In another embodiment, in addition to ReLU networks, program 150 adds the manifold alignment constraint to a counterfactual optimization model when underlying models are logistic regression, decision trees, and tree ensembles, etc.

In an embodiment, program 150 formulates a constraint LO [symbol] (x)≤t utilizing in total n+n·k+n·n=O(n²) (assuming) new binary variables. In another embodiment, for k=1, LO [symbol] (x), program 150 introduces n+n=O(n) new binary variables.

The present invention solves the initial large, hard-to-solve problem (2) and (3) by transforming said problems into a sequence of easier-to-solve optimization problems with fewer decision variables by exploiting the geometry of ReLU networks.

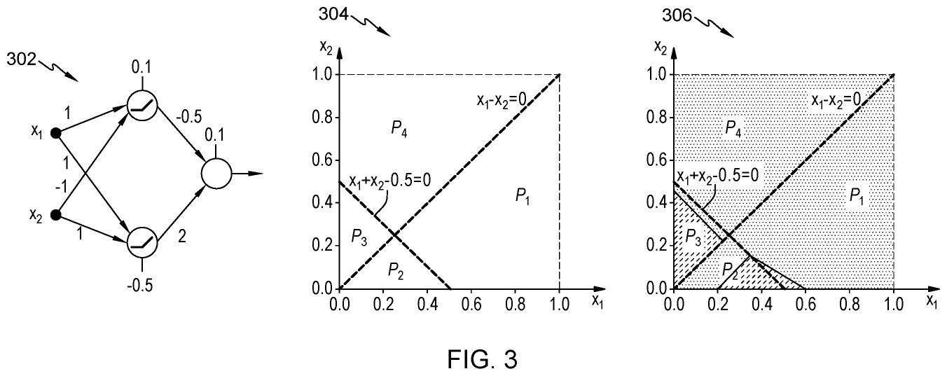

Program 150 decomposes an input space based on trained model geometry (step 206). In an embodiment, program 150 fixes an activation patten on one or more hidden layers of neural network 152 (or equivalently when binary variables zⁱ of problem (2)), reducing neural network 152 into a linear model. In another embodiment, program 150 creates a feasible set of the linear model that is a polyhedron, where the polyhedron is a subset of an input space χ. In another embodiment, program 150 utilizes the feasible sets, from all feasible ReLU activation patterns) to partition χ into a finite number of polyhedral such that Pⱼ∩P_{j′}=∅, ∀j≠j′, and ∪ⱼPⱼ=χ. FIG. 3 further illustrates the partition scheme.

In an embodiment, where a setting has two features x₁, x₂, where χ=[0,1]² and a trained one-layer ReLU network (e.g., neural network 152), as depicted in FIG. 3, specifically 302. In an embodiment, program 150 enumerates all possible activation patterns for a hidden layer to obtain for convex polyhedra, P₁, P₂, P₃, and P₄, that partition an input space χ as show in FIG. 3, specifically 304. In an embodiment, the partitions are:

$${P}_{1} = \{ ( {x}_{I} , {x}_{2} ) ∈ 𝒳 : {x}_{1} - {x}_{2} \geq 0 , {x}_{1} + {x}_{2} - 0.5 \geq 0 \} ,$$

$${P}_{2} = \{ ( {x}_{1} , {x}_{2} ) ∈ 𝒳 : {x}_{1} - {x}_{2} \geq 0 , {x}_{1} + {x}_{2} - 0.5 < 0 \} ,$$

$${P}_{3} = \{ ( {x}_{1} , {x}_{2} ) ∈ 𝒳 : {x}_{1} - {x}_{2} < 0 , {x}_{1} + {x}_{2} - 0.5 \geq 0 \} ,$$

$${P}_{4} = \{ ( {x}_{1} , {x}_{2} ) ∈ 𝒳 : {x}_{1} - {x}_{2} < 0 , {x}_{1} + {x}_{2} - 0.5 < 0 \} .$$

FIG. 3 further demonstrates that a final partition of an input space χ, where all instances that belong to dashed polytopes are predicted to belong to a negative class and all instances that belong to shaded polytopes are predicted to belong to a positive class. In an embodiment, for a given polytope Pⱼ, program 150 calculates a decision boundary by solving a linear equation f(x)=0 for x∈Pⱼ.

In another embodiment, for a trained neural network 152, program 150 optimally solves equation (2) and equation (3) by enumerating all feasible polytopes Pⱼ while solving an optimization problem over each Pⱼ. In yet another embodiment, program 150 obtains a feasible polytope equivalent to setting the zⁱ binary variables to a corresponding activation pattern. In an embodiment, program 150 solves problem (2) by solving a single generalized linear program (LP), if p∈{1, ∞}, or a single quadratic programming (CQP) problem (p=2) for each feasible polytope Pⱼ. In another embodiment, program 150 solves problem (3) by solving a significantly smaller MIP due to the binary variables zⁱ being fixed. In an embodiment, responsive to neural network 152, program 150 solves problems (2) and (3) by solving four smaller (e.g., more computational efficient) optimization problems and output as x_{CF} the solution that gives a lowest objective value out of the four problems, wherein the output is predicted to achieve the outcome by the trained neural network 152. In an embodiment, program 150 calculates a series of optimization problems with the LOF constraint for a set of closest polytopes. In an embodiment, program 150, responsively, updates one or more counterfactual predictions with the minimum distance with respect to the input sample point X_{F}.

The present invention recognizes that the above embodiments allow for generalization and requires solving N smaller (i.e., more computational efficient (i.e., requiring fewer computational resources)), where N is a number of all feasible polytopes. In some embodiments, N becomes very large (i.e., exponential with respect to parameters of neural network 152, up to

$${\sum }_{( {j}_{1 , … ,} {j}_{L} ) ∈ J} {\prod }_{l = 1}^{L} \{ \begin{matrix}{n}_{l} \\ {j}_{l}\end{matrix} \} ,$$

where J={(j₁, . . . , j_{L})}∈ [symbol] ^{L}:0≤j_{L}≤min{nₒ, nₒ−j₁, . . . , nₗ₋₁−jₗ₋₁}, ∀l=1, . . . , L} which inverses affects large ReLU networks. In the embodiments below, program 150 circumvents this computational hurdle thus increasing computation efficiency.

Program 150 generates a counterfactual based on the plurality of polytopes (step 208). In an embodiment, program 150 approximates a solution of an initial MIP by solving a moderate number of smaller optimization problems by searching over live polytopes. In another embodiment, given a trained ReLU network f (i.e., neural network 152), a live polytope of f is a feasible polytope generated by f that contains at least one actual data point of [symbol] ₊. In an embodiment, as depicted in FIG. 3, the live polytopes are partitions of an input space X that contain data points with crosses. Based on FIG. 3, program 150 only is required to solved two sub-problems that correspond to polytopes P₂ and P₃, since P₁ and P₄ do not contain positive data points, which reduces the complexity of the problem from solving four sub-problems to solving two sub-problems.

In an embodiment, program 150 applies this step to neural network 152, reducing complexity of solving N sub-problems to solving at most n₊<n, thus improving computation tractability compared to an initial MIP formulation. In an embodiment, as a size of neural network 152, f, and the dataset [symbol] ₊ increases, a number of live polytopes may also increase, resulting in a cost (e.g., computational) of search being determined by an exhaustive exploration of all live polytopes. Embodiments of the present invention recognize that a nearest counterfactual explanation is more likely to be found within one of the closest live polytopes to x_{F}, rather than within one of the more distant polytopes.

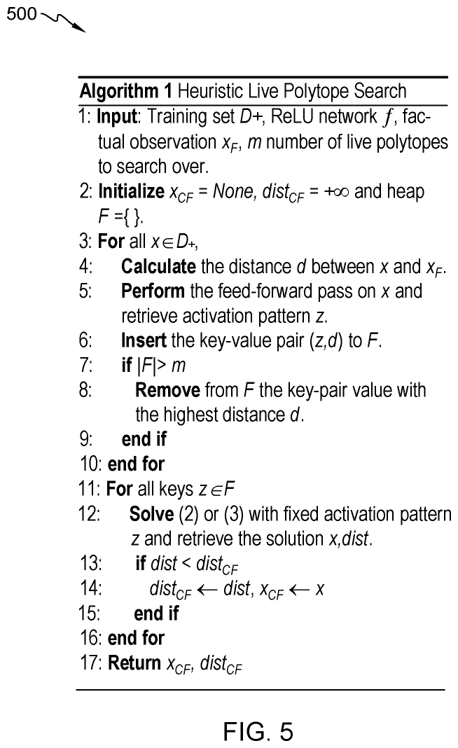

In an embodiment, program 150 utilizes a heuristic that only searches over a subset of the closest live polytopes. In an embodiment, program 150 utilizes the heuristic to receives a user-defined quantity m as an input, which specifies a maximum number of live polytopes to search over. In an embodiment, program 150 retrieves a user-defined integer m as an input. In another embodiment, program 150, responsively, calculates a distance between all points in [symbol] ₊ and x_{F} and retrieves a m live polytopes that contain a point within a minimum distance to x_{F}. This step is further demonstrated in FIG. 5. In an embodiment, program 150 analytically characterizes a probability of missing a polytope that contains an optimal counterfactual explanation under the above heuristic. In an embodiment, a probability of not selecting a live polytope that leads to a closest counterfactual, drops exponentially as m increases.

In another embodiment, program 150 defines a distance between a data point, denoted as x∈ [symbol] ₊, and a nearest point to x_{F} belonging a same live polytope as x, follows a known distribution, responsively, program 150 establishes an upper threshold for a probability of not selecting a live polytope that results in the closest counterfactual. In an embodiment, program 150 obtains a value of m necessary to achieve a probability of error less than or equal to this threshold by solving for m. In an embodiment, program 150 compares a difference in X_{CF} to indicate necessary changes (i.e., counterfactual) in X_{F} to satisfy a model outcome (e.g., loan approval).

The present invention recognizes that a property of the proposed invention, is that live polytope search, even when employed without manifold-adhering constraints, yields more realistic counterfactual explanations than original MIP alone, due to the input space χ being [symbol] ^{d}, the data [symbol] resides in a manifold or subset of [symbol] ^{d}. As a result, program 150 estimates a distribution of the data and responsively solves problem (2) and (3) with respect to the estimated distribution, in order to retrieve or calculate a realistic counterfactual explanation. In an embodiment, program 150 utilizes live polytope search implicitly to address said issue by performing a nonparametric probability density estimate.

Program 150 presents the generated counterfactual (step 210). In an embodiment, program 150 transmits or presents the generated counterfactual to a user. For example, program 150 presents the generated counterfactual to the user utilizing a user interface associated with a user computing device. Based on a LOF score, program 150 may adjust the prioritization of a counterfactual dependent on the capabilities of the associated user computing device. Responsive to the LOF score, program 150 generates, displays, modifies, or presents the counterfactual distinguishably (e.g., distinctively) from previous, prior, or historical counterfactuals. Program 150 may generate, adjust, modify, transform, and/or present the appearance of a plurality of stylistic elements of the presented counterfactual. In an embodiment, said plurality may include; adjustments to font, font size, character style (e.g., bold, italics, font color, background color, superscript, subscript, capitalization), general transparency, relative transparency, etc. For example, program 150 applies a “bold” adjustment to a loan counterfactual that is out of range (e.g., too expensive, infeasible) for an associated business. In an embodiment, program 150 displays the LOF score or counterfactual probability in proximity to the corresponding counterfactual. In another embodiment, program 150 replaces the counterfactual with the associated probability. In an embodiment, program 150 retrieves, queries, prompts, or determines user preferences or settings detailing user preferred prioritization adjustments such as level of transparency, and text color preferences. In an embodiment, program 150 generates a hypertext markup language webpage comprising the generated counterfactual. For example, program 150 creates one or more webpages that comprise a counterfactual that explains and provides steps to reduce computational resources (i.e., model outcome) of an associated system. In this example, the provided steps include program instructions to effectuate the reduction (e.g., counterfactual).

FIG. 3 depicts example 300, in accordance with an illustrative embodiment of the present invention. Examples 300 contains model 302, partition 304, and partition 306. Model 302 depicts a one-layer ReLU neural network (e.g., neural network 152). Partition 304 depicts a partition of the input space χ by the hidden layer of the ReLU network into 4 polytopes. Partition 306 depicts a final partition of the input space χ by the output neuron of the ReLU network, i.e. [symbol] [f(x)≥0.5], between positive and negative regions. Partition 306 further demonstrates that a final partition of an input space χ, where all instances that belong to dashed polytopes are predicted to belong to a negative class and all instances that belong to shaded polytopes are predicted to belong to a positive class. In an embodiment, for a given polytope Pⱼ, program 150 calculates a decision boundary by solving a linear equation f(x)=0 for x∈Pⱼ.

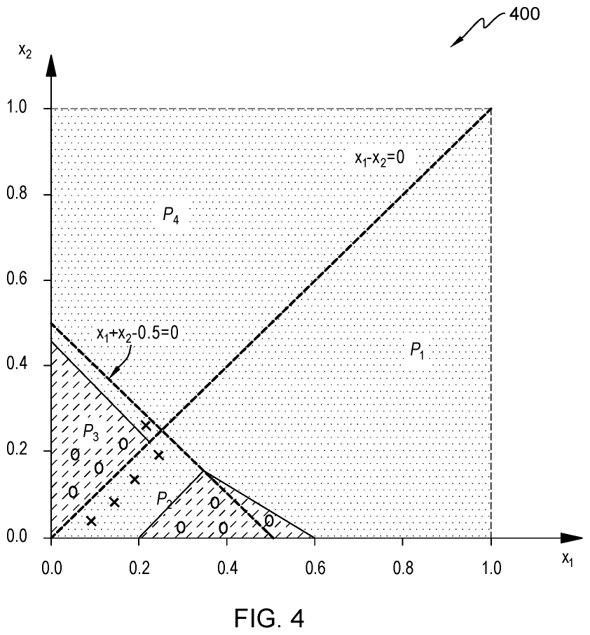

FIG. 4 depicts example 400, in accordance with an illustrative embodiment of the present invention. Example 400 depicts a final partition of the input space χ for model depicted in model 302. The crosses correspond to positive data points and the circles correspond to negative data points. P₂ and P₃ are live polytopes due to said polytopes containing positive data points.

FIG. 5 depicts heuristic 500, in accordance with an illustrative embodiment of the present invention. Heuristic 500 is a live polytope search heuristic that illustrates the operational steps of FIG. 2.

What is claimed is:

1. A computer-implemented method comprising:
responsive to receiving an input, a trained model, a trained model outcome, a local outlier factor (LOF) threshold, and a maximum number of live polytopes to search over, generating an optimization problem to determine an output that is closest to the input with respect to a distance measure;
transforming a LOF constraint into a set of linear mixed integer constraints and a set of quadratic mixed integer constraints, utilizing the distance measure;
decomposing an input space into a plurality of polytopes based on a geometry associated with the trained model; and
generating a counterfactual based on the plurality of polytopes.

2. The computer-implemented method of claim 1, further comprising:
presenting the generated counterfactual.

3. The computer-implemented method of claim 1, wherein the generated counterfactual satisfies a manifold alignment constraint.

4. The computer-implemented method of claim 1, wherein decomposing the input space into the plurality of polytopes based on the geometry associated with the trained model, comprises:
calculating a series of optimization problems with the LOF constraint for a set of closest polytopes.

5. The computer-implemented method of claim 1, wherein the plurality of polytopes contains a point within a minimum distance to the input.

6. The computer-implemented method of claim 1, wherein the trained model is a trained rectified linear unit network.

7. The computer-implemented method of claim 4, further comprising:
updating the counterfactual with a minimum distance with respect to the input.

8. A computer program product comprising:
one or more computer readable storage media having computer-readable program instructions stored on the one or more computer readable storage media, said program instructions executes a computer-implemented method comprising steps of:
responsive to receiving an input, a trained model, a trained model outcome, a local outlier factor (LOF) threshold, and a maximum number of live polytopes to search over, generating an optimization problem to determine an output that is closest to the input with respect to a distance measure;
transforming a LOF constraint into a set of linear mixed integer constraints and a set of quadratic mixed integer constraints, utilizing the distance measure;
decomposing an input space into a plurality of polytopes based on a geometry associated with the trained model; and
generating a counterfactual based on the plurality of polytopes.

9. The computer program product of claim 8, wherein the program instructions, stored on the one or more computer readable storage media, further comprise the steps of:
presenting the generated counterfactual.

10. The computer program product of claim 8, wherein the generated counterfactual satisfies a manifold alignment constraint.

11. The computer program product of claim 8, wherein the program instructions to decompose the input space into the plurality of polytopes based on the geometry associated with the trained model, stored on the one or more computer readable storage media, comprise the steps of:
calculating a series of optimization problems with the LOF constraint for a set of closest polytopes.

12. The computer program product of claim 8, wherein the plurality of polytopes contains a point within a minimum distance to the input.

13. The computer program product of claim 8, wherein the trained model is a trained rectified linear unit network.

14. The computer program product of claim 11, wherein the program instructions, stored on the one or more computer readable storage media, further comprise the steps of:
updating the counterfactual with a minimum distance with respect to the input.

15. A computer system comprising:
one or more computer processors;
one or more computer readable storage media having computer readable program instructions stored on the one or more computer readable storage media for execution by at least one of the one or more processors, the stored program instructions execute a computer-implemented method comprising steps of:
responsive to receiving an input, a trained model, a trained model outcome, a local outlier factor (LOF) threshold, and a maximum number of live polytopes to search over, generating an optimization problem to determine an output that is closest to the input with respect to a distance measure;
transforming a LOF constraint into a set of linear mixed integer constraints and a set of quadratic mixed integer constraints, utilizing the distance measure;
decomposing an input space into a plurality of polytopes based on a geometry associated with the trained model; and
generating a counterfactual based on the plurality of polytopes.

16. The computer system of claim 15, wherein the program instructions, stored on the one or more computer readable storage media, further comprise the steps of:
presenting the generated counterfactual.

17. The computer system of claim 15, wherein the generated counterfactual satisfies a manifold alignment constraint.

18. The computer system of claim 15, wherein the program instructions to decompose the input space into the plurality of polytopes based on the geometry associated with the trained model, stored on the one or more computer readable storage media, comprise the steps of:
calculating a series of optimization problems with the LOF constraint for a set of closest polytopes.

19. The computer system of claim 15, wherein the plurality of polytopes contains a point within a minimum distance to the input.

20. The computer system of claim 15, wherein the trained model is a trained rectified linear unit network.
